(19) United States
(12) Patent Application Publication
(10) Pub. No.: US 2003/0050790 A1
(43) Pub. Date: Mar. 13, 2003

(54) Business card processing system and method

(76) Inventors: William Chang, Taipei (TW); James Huang, Taipei (TW); Minu Liu, Taipei (TW)

Correspondence Address: BIRCH STEWART KOLASCH & BIRCH, PO BOX 747, FALLS CHURCH, VA, 22040-0747, US

(21) Appl. No.: 10/003,439

(22) Filed: Dec. 6, 2001

(30) Foreign Application Priority Data
Sep. 12, 2001 (TW) 90122682

(51) Int. Cl. G06F 17/60

(52) U.S. Cl. 705/1

(57) ABSTRACT

A business card processing system, which includes a data-extracting module and an appending module. The data-extracting module analyzes a business card file and extracts object data from the business card file. The appending module appends a corresponding field name to the object data, so that a customer can modify the object data with reference to the corresponding field name via a network, and preview a network image file transformed from the object data via the network. In a preferred embodiment of the invention, the data-extracting module and the appending module are macro language program modules in an image processing software.

### BACKGROUND OF THE INVENTION

1. Field of the Invention

The invention relates to a business card processing system, which utilizes an image processing software to process the data of the business card directly, and allows a customer to edit the data of the business card via a network.

2. Related Art

According to conventional procedures to produce business cards, one must first produce a card sample, and send or mail the card sample to a printing house. The printing house then makes a plate of the card sample to print business cards. When the data on the business card are to be changed, one must produce another card sample, and send it to the printing house again. The printing house then must make another plate of the new card sample. While the document flow procedures in a company are taken into consideration as well, it is apparent that the overall procedures of printing business cards are complex, inconvenient and time-consuming.

Thanks to the development of computer and network technologies, it has common to print business cards with the aid of computers and networks presently. Referring to FIG. 1, in the traditional procedures of printing business cards with the aid of computer and network technologies, a card-processing company first receives a card sample sent from a customer in procedure 101. The card sample may be an image file sent via the network or an actual business card sample sent via mail. Then, in the procedure 102, the card-processing company generates a “template”. The template is a web page representing the layout design of the business card, and is generated by an employee of the card-processing company using web page editing software. The customer can browse the template via a network using a WWW browser to preview the layout design of the business card.

Since the template is a web page, as long as the design of the business card is not changed, the card-processing company can edit the data on the template using the web page editing software directly without producing another template. Therefore, in procedure 103, the card-processing company edits data on the template directly to modify the name, extension number or email address on the business card.

The card-processing company can also store the template data in a database, and link the template to the database. Then, the card-processing company can provide active server pages for the customer to edit the data of the template stored in the database via the network.

Since the customer can browse the template to see whether or not the data are correct, the card-processing company can add a “confirm” button on the active server pages or the template. If the data are correct, the customer can click the button directly to send a confirmation message to the card-processing company via the network.

After receiving the confirmation message, the card-processing company then produces an image file manually using image-processing software, and sends this image file to the printing house to print business cards in procedure 104.

One disadvantage of the above-mentioned procedures is that there is a high possibility that the appearance of the original card sample, the template and the business card printed are not the same. After receiving the card sample, an employee of the card-processing company must use the web page editing software to produce the template in accordance with the card sample manually, even if the card sample is already a computer-readable image file. Before printing, the employee must use image-processing software to produce another image file manually in accordance with the template, and save the image file into a specific format acceptable to the printing house. These procedures result in differences between the card sample, the template and the business card printed. Therefore, the business card printed might be different from the original card sample or the template that the customer previewed via the network.

Another disadvantage is that the cost of the above-mentioned procedures is high. Since the card sample is transformed into the template by web page editing software, and the template is transformed into the image file by an image processing software, the card-processing company must have employees skilled in both the web page editing software and the image processing software. And, the transformation procedures must be accomplished manually. Therefore, the above-mentioned procedures result in high overall costs.

### SUMMARY OF THE INVENTION

In view of the above disadvantages, an objective of the invention is to provide a business card processing system and method, which can reduce the difference between the original card sample, the template that the customer previewed and the business card printed.

Another objective of the invention is to provide a business card processing system and method, which can reduce the costs in printing business cards.

To achieve the above objectives, the business card processing system according to the invention includes a data-extracting module and an appending module. The data-extracting module analyzes a business card file and extracts object data from the business card file. The appending module appends a corresponding field name to the object data, so that a customer can modify the object data with reference to the corresponding field name via a network, and preview a network image file transformed from the object data via the network.

In a preferred embodiment of the invention, the data-extracting module and the appending module are macro language program modules in an image processing software.

In another preferred embodiment of the invention, the appending module appends the corresponding field name to the object data by prompting a corresponding field name list to a user and allowing the user to select the corresponding field name from the corresponding field name list.

In another preferred embodiment, the business card processing system further includes an interactive web page, which is generated with reference to the corresponding field name for the customer to browse, modify and store the object data via the network.

The invention also provides a business card processing method, which analyzes and extracts object data from a business card file, and appends a corresponding field name to the object data. Then, a customer can modify the object data with reference to the corresponding field name and preview a network image file transformed from the object data via a network.

Since the business card processing system and method according to the invention allows the card-processing company to process the original business card file directly, the differences between the business card file and the business card printed can be eliminated, and the overall cost can be reduced.

Further scope of the applicability of the invention will become apparent from the detailed description given hereinafter. However, it should be understood that the detailed description and the specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a flowchart showing the procedures of business card printing in prior art;

FIG. 2 is a block diagram showing the business card processing system according to a preferred embodiment of the invention;

FIG. 3 is a screen shot showing the status when the appending module prompts a corresponding field name list;

FIG. 4 is a screen shot showing an interactive web page generated by the business card processing system;

FIG. 5 is a screen shot showing a preview page generated by the business card processing system; and

FIG. 6 is a flowchart showing the procedures of the business card processing method according to the preferred embodiment of the invention.

### DETAILED DESCRIPTION OF THE PREFERRED EMBODIMENT

A preferred embodiment of the invention will be described with reference to the accompanying drawings, wherein the same references relating to the same elements.

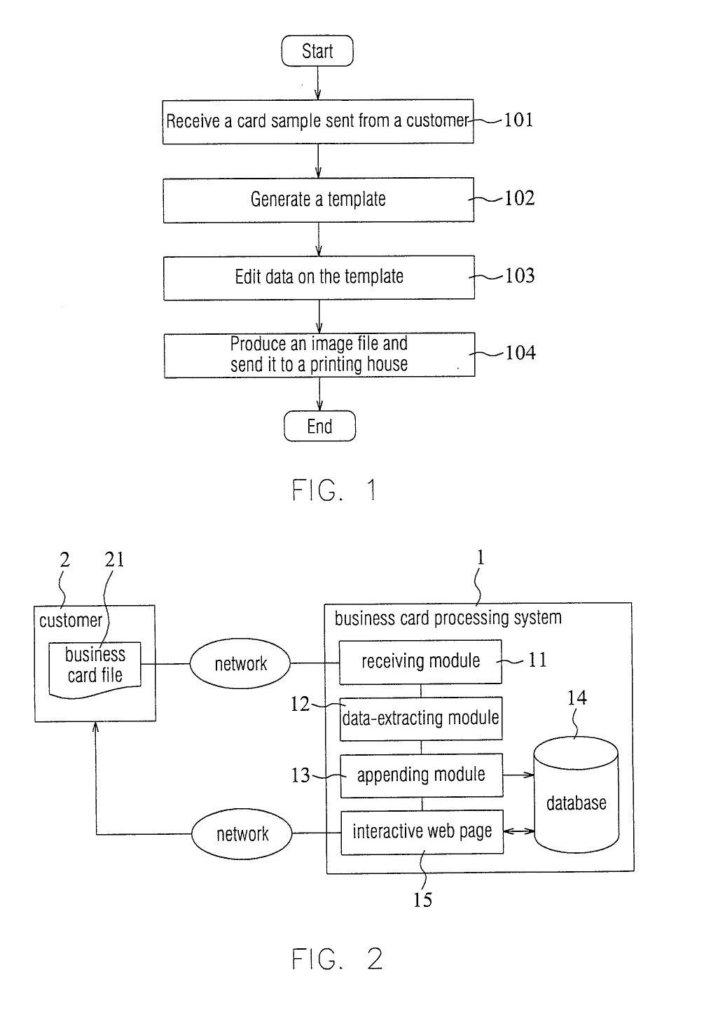

Referring to FIG. 2, the business card processing system 1 according to a preferred embodiment of the invention includes a receiving module 11, a data-extracting module 12, an appending module 13, a database 14 and an interactive web page 15. In the preferred embodiment, the business card processing system 1 is a computer having a CPU, data storage devices such as DRAM and hard disk drive, input devices such as a keyboard and a mouse, and output device such as a CRT or LCD display.

The receiving module 11 may be arbitrary kind of network interface module providing services at the data link level of the network, and is able to receive a business card file 21 sent from a customer via a network. In the preferred embodiment, the business card file 21 is an image file or a data file generated by CorelDraw or any other image processing software. For example, if the customer uses CorelDraw, the business card file 21 may be a *.cdr file, which is a data file of an image, or a *.crf file, which is a text file containing information of the image.

In the preferred embodiment, the data-extracting module 12 is a macro language program module, for example, a VBA (Visual Basic for Application) macro in CorelDraw. When a user loads the business card file 21 into CorelDraw, the user can enable the data-extracting module 12 to analyze the data of the image blocks and text blocks, and extract object data from the business card file 21.

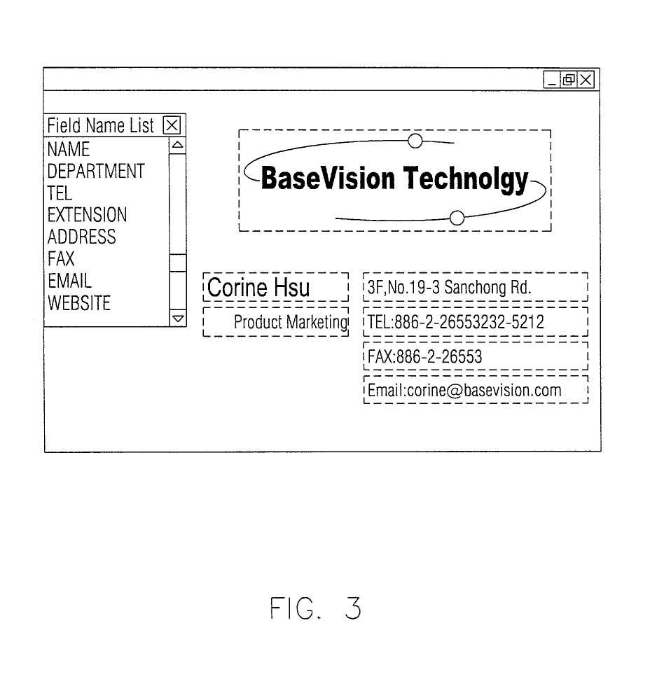

The appending module 13 is another VBA macro in CorelDraw, which appends corresponding field names to the object data. Referring to FIG. 3, the appending module 13 prompts a corresponding field name list 31 for a user, and allows the user to select a corresponding field name from the corresponding field name list for each object data. For example, the user may select the corresponding field name “Name” for “Corine Hsu”, and another corresponding field name “Department” for “Product Marketing”.

In the preferred embodiment, the object data includes static data and variable data. The static data are data on the business card that are common to all persons, such as the logo of the company. The variable data are data that might vary with each individual, such as the name and the extension number of an employee of the company. Since the static data are invariable, the appending module 13 may just append the corresponding field name to the variable data. The reason for only appending the corresponding field name to the variable data will be described later.

The database 14 stores the object data and the corresponding field names, and can be arbitrary kind of conventional electronic database, or just a text file containing the corresponding relationship between the object data and the corresponding field names.

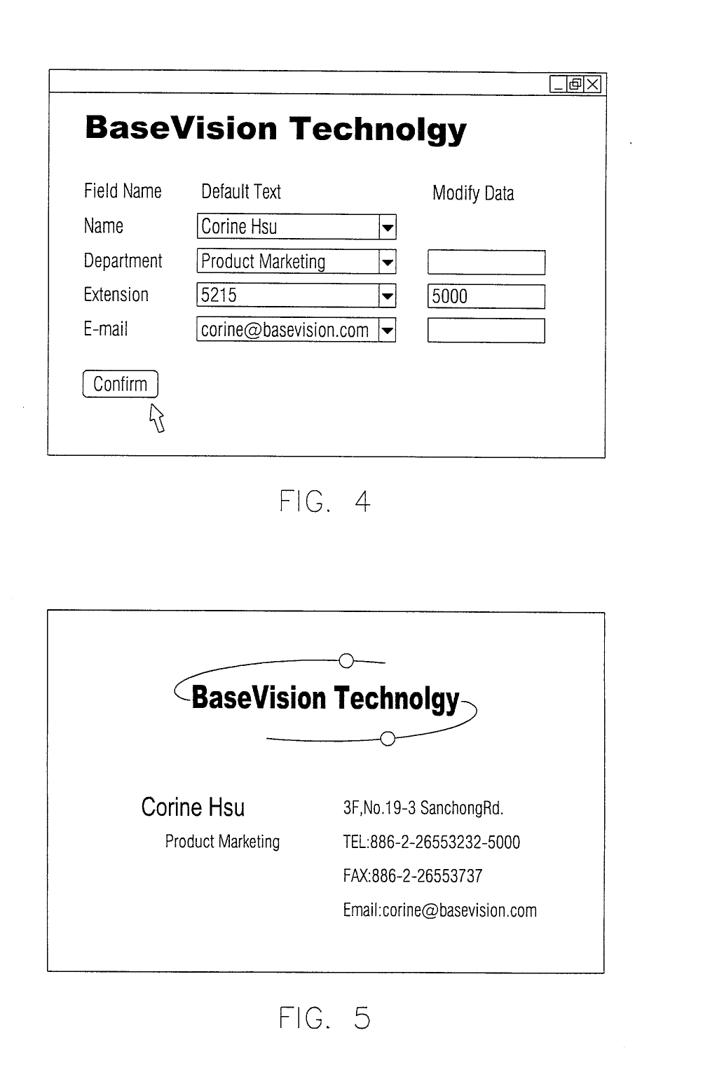

The interactive web page 15 is generated with reference to the corresponding field names. Referring to FIG. 4, the interactive web page 15 retrieves data from the database 14, and provides a plurality of text areas. The corresponding field names appear near each of the corresponding text areas. The default texts in the text areas are the variable data stored in the database 14. The customer can browse the variable data stored in the database 14 via the network, and modify them by entering new data in the text areas and clicking the “Confirm” button on the interactive web page 15.

Once the customer entered a new set of variable data, these new variable data can be stored in the database 14 as a “profile” of an employee. If the employee needs more business cards, the customer can recall the variable data of this employee by selecting them from a drop-down menu of the interactive web page 15.

As mentioned above, the appending module 13 may just append the corresponding field names to the variable data. It is because only corresponding field names of the variable data appeared in the interactive web page 15 for the customer to modify. Therefore, one can choose not to append the corresponding field names to the static data to reduce the size of the database 14.

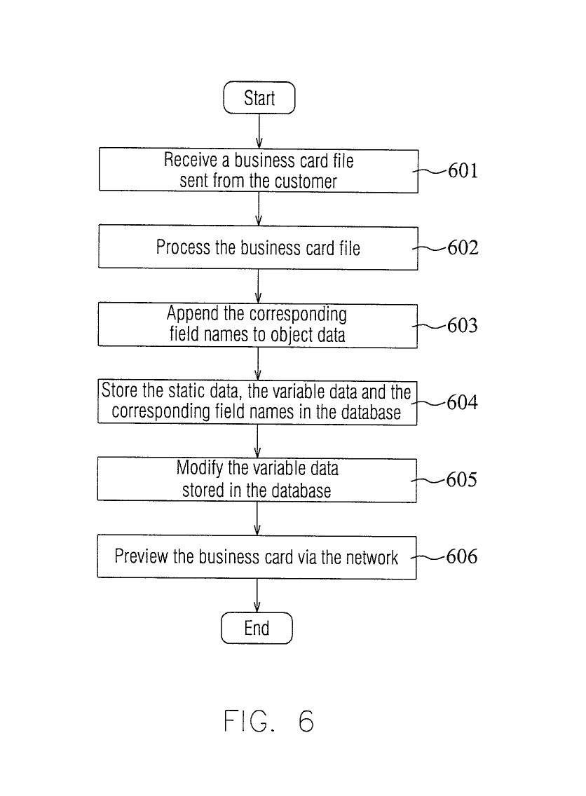

Referring to FIG. 5, in the preferred embodiment, once the customer sends a confirmation message to the card-processing company, the variable data stored in the database 14 entered or selected by the customer is used to replace the corresponding data in the *.crf file. Then, when the customer wishes to preview the business card via the network, the *.crf file can be transformed into a network image file, for example, a *.png file, for the customer to preview the business card via the network.

An example of the procedures of the business card processing method is described below with reference to FIG. 6.

Referring to FIG. 6, the card-processing company receives a business card file 21 sent from the customer via the network in procedure 601. The business card file 21 is a *.crf file generated by the customer using CorelDraw.

Then, in procedure 602, the card-processing company loads the *.crf file into CorelDraw, and enables the data-extracting module 12 to process the *.crf file. The object data, including the static data and the variable data, are extracted from the *.crf file.

The appending module 13 is enabled to append the corresponding field names to the object data in procedure 603. As mention above, the corresponding field names can be only appended to the variable data.

Then, in procedure 604, the static data, the variable data and the corresponding field names are stored in the database 14. As mentioned above, since the contents of the interactive web page 15 is linked to the database 14, the customer can browse the interactive web page 15 using a web browser via a network, and modify the variable data stored in the database 14 in procedure 605.

After modifying the variable data in the database 14, the modified variable data is used to replace the corresponding data in the *.crf file. Then, in procedure 606, the *.crf file is transformed into a *.png file for the customer to preview the business card via the network.

The business card processing system and method according to the invention allows the card-processing company to process the original business card file directly. Therefore, the differences between the original business card file provided by the customer, the network image file previewed by the customer and the business card printed can be significantly reduced. Therefore, the customer can receive printed business cards with exactly the same layout design as the network image file the customer previewed via the network and the original card sample.

Furthermore, according to the invention, the employee of the card-processing company can process the business card file using an image processing software directly. Therefore, the manpower, the cost of business card processing can be significantly reduced.

While the invention has been described with reference to a preferred embodiment, this description is not intended to be construed in a limiting sense. Various modifications of the embodiment will be apparent to persons skilled in the art upon reference to the description. Therefore, it is intended that the appended claims encompass any such modifications.

What is claimed is:

1. A business card processing system, comprising:
a data-extracting module for analyzing a business card file and extracting object data from the business card file; and
an appending module for appending a corresponding field name to the object data, so that a customer being able to modify the object data with reference to the corresponding field name and preview a network image file transformed from the object data via a network.

2. The business card processing system according to claim 1, wherein the data-extracting module and the appending module are macro language program modules in an image processing software.

3. The business card processing system according to claim 1, wherein the object data comprises static data and variable data.

4. The business card processing system according to claim 1, further comprising:
a database for storing the object data and the corresponding field name.

5. The business card processing system according to claim 1, further comprising:
an interactive web page, which is generated with reference to the corresponding field name for the customer to browse, modify and store the object data via the network.

6. The business card processing system according to claim 1, wherein the appending module appends the corresponding field name to the object data by prompting a corresponding field name list to a user and allowing the user to select the corresponding field name from the corresponding field name list.

7. The business card processing system according to claim 1, wherein the customer via the network sends the business card file.

8. A business card processing method, comprising:
analyzing and extracting object data from a business card file; and
appending a corresponding field name to the object data, so that a customer can modify the object data with reference to the corresponding field name and preview a network image file transformed from the object data via a network.

9. The business card processing method according to claim 8, wherein
analyzing and extracting the object data from the business card file is accomplished by using a data-extracting module;
appending the corresponding field name to the object data is accomplished by using an appending module; and
the data-extracting module and the appending module are macro language program modules in an image processing software.

10. The business card processing method according to claim 8, wherein the object data comprises static data and variable data.

11. The business card processing method according to claim 8, further comprising:
prompting a corresponding field name list to a user; and
allowing the user to select the corresponding field name from the corresponding field name list to append the corresponding field name to the object data.

12. The business card processing method according to claim 8, further comprising:
storing the object data and the corresponding field name into a database.

13. The business card processing method according to claim 8, further comprising:
generating an interactive web page with reference to the corresponding field name for the customer to browse, modify and store the object data via the network.

14. The business card processing method according to claim 8, further comprising:
receiving the business card file sent by the customer via the network.

15. A computer-readable storage medium containing program code for a computer to perform a business card processing method, the business card processing method comprising the procedures of:
analyzing and extracting object data from a business card file; and
appending a corresponding field name to the object data, so that a customer can modify the object data with reference to the corresponding field name and preview a network image file transformed from the object data via a network.

16. The computer-readable storage medium according to claim 15, wherein
analyzing and extracting the object data from the business card file is accomplished by using a data-extracting module;
appending the corresponding field name to the object data is accomplished by using an appending module; and
the data-extracting module and the appending module are macro language program modules in an image processing software.

17. The computer-readable storage medium according to claim 15, wherein the object data comprises static data and variable data.

18. The computer-readable storage medium according to claim 15, wherein the business card processing method further comprises the procedures of:
prompting a corresponding field name list; and
allowing a user to select the corresponding field name from the corresponding field name list to append the corresponding field name to the object data.

19. The computer-readable storage medium according to claim 15, wherein the business card processing method further comprises the procedure of:
storing the object data and the corresponding field name into a database.

20. The computer-readable storage medium according to claim 15, wherein the business card processing method further comprises the procedure of:
generating an interactive web page with reference to the corresponding field name for the customer to browse, modify and store the object data via the network.

21. The computer-readable storage medium according to claim 15, wherein the business card processing method further comprises the procedure of:
receiving the business card file sent by the customer via the network.
